(19) United States
(12) Patent Application Publication
(10) Pub. No.: US 2006/0288065 A1
(43) Pub. Date: Dec. 21, 2006

(54) Method and apparatus for lapped transform coding and decoding

(75) Inventor: Dan Lelescu, Morgan Hill, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: DoCoMo Communications Laboratories USA, Inc.

(21) Appl. No.: 11/454,969

(22) Filed: Jun. 15, 2006

Related U.S. Application Data
(60) Provisional application No. 60/691,758, filed on Jun. 17, 2005.

(51) Int. Cl. G06F 17/10

(52) U.S. Cl. 708/300

(57) ABSTRACT

A method, apparatus, and article of manufacture for deriving and using non-linearly adapted lapped transforms (NALTs) In one embodiment, the method comprises receiving parameters of a statistical fit between local statistics of original and processed frame data, determining adaptation parameters for application of an inverse lapped transform to frame data, and filtering the frame data in response to filtering adaptation parameters.

### PRIORITY

The present patent application claims priority to and incorporates by reference the corresponding provisional patent application Ser. No. 60/691,758, titled, “Method And Apparatus For Lapped Transform Coding and Decoding,” filed on Jun. 17, 2005.

### FIELD OF THE INVENTION

The present invention relates to the field of lapped transform coding; more particularly, the present invention relates to adaptive lapped transform coding with reduced overhead.

### BACKGROUND OF THE INVENTION

One of the elements of transform coding of data is represented by the application of a transform to the data. Using block transforms to independently process blocks of data in an image limits the coding performance and may create undesirable blocking artifacts visible in the reconstructed images. In order to reduce these artifacts, a certain amount of overlap among the blocks can be taken into account in the transform coding process, thus resulting in the use of lapped transforms for image or video coding and decoding. The design of the lapped transform is important for the rate-distortion performance of the transform coding and decoding process, as well as for determining the degree to which the blocking artifacts can be reduced.

A lapped orthogonal transform (LOT) was introduced in H. S. Malvar and D. H. Staelin, “The LOT: Transform Coding Without Blocking Effects,” IEEE Transactions on Acoustics, Speech, and Signal Processing, vol. ASSP-37, pp. 553-559, April 1989, based on the work in Cassereau, “A New Class of Optimal Unitary Transforms for Image Processing,” M. S. Thesis, Mass. Inst. Tech., May 1985. The LOT is an orthogonal transform designed based on the Discrete Cosine Transform (DCT) basis functions. The LOT can provide an improvement over the block DCT, by reducing the blocking artifacts. However, since the tails of the lower frequency basis functions of the LOT do not exactly decay to zero, there are still some blocking artifacts that remain in the image, especially at low data bit rates.

In order to address the shortcomings of the LOT, a lapped biorthogonal transform (LBT) was proposed in H. S. Malvar, “Biorthogonal and Non-uniform Lapped Transforms for Transform Coding with Reduced Blocking and Ringing Artifacts,” IEEE Transactions on Signal Processing, vol. 46, pp. 1043-1053, April 1998 and R. L. de Queiroz, T. Q. Nguyen, and K. R. Rao, “The Generalized Lapped Orthogonal Transforms,” Electronics Letters, vol. 30, January 199, by making a change in the LOT through a scaling of the samples in the tails of the basis functions of the forward and inverse lapped transform.

A lapped orthogonal transform can be generalized by increasing the amount of overlap across multiple blocks of data. Thus, a generalized LOT (GenLOT) results. See R. L. de Queiroz, T. Q. Nguyen, and K. R. Rao, “The Generalized Lapped Orthogonal Transforms,” Electronics Letters, vol. 30, January 1994 and R. L. de Queiroz, T. Q. Nguyen, and K. R. Rao, “The GenLOT: Generalized Linear Phase Lapped Orthogonal Transform,” IEEE Transactions on Signal processing, vol. 44, pp. 497-507, March 1996.

A lifted lapped transform implementation has been used previously, but this is a non-adaptive transform. An inverse lapped transform exists that attempts to correct the artifacts introduced by the use of the DCT transform in the encoder, by weighting the coefficients of the inverse lapped transform. The weighting decision is dependent on the discrimination of blocking artifact effects from real image features in the transformed and reconstructed data, which is unreliable and difficult. The weighting is applied to the inverse lapped transform only and results in essentially a weighted post-processing approach.

While lapped transforms reduce the blocking artifacts in an image, they may also generate ringing artifacts due to the longer basis functions of the transform that extend possibly across multiple blocks. To alleviate this problem, variable length lapped transforms (VLLOT) have been proposed. These transforms have long basis functions meant to reduce the blocking artifacts as well as short basis functions that can reduce ringing artifacts.

Existing lapped transforms used in image and video coding are determined based on a set of a priori statistical assumptions about the data being processed. In the majority of cases, these assumptions are not satisfied in practice. Thus, a mismatch exists between the design of the lapped transform and the characteristics of the data to which it is applied. Furthermore, in most cases, either a unique lapped transform is used to process all blocks in an image, or at most the length of the basis functions of the transform is varied. This transform design lacks the adaptation needed in the structure of its basis functions (whether of fixed or variable length) to capture and exploit the statistical variation in the image data to which it is applied. Furthermore, if local adaptation provisions are present, the resulting overhead is large which has a negative impact on the overall performance of the process. Adapting only the inverse lapped transform based only on characteristics of the reconstructed data that is available at the decoder is another limiting factor.

### SUMMARY OF THE INVENTION

A method, apparatus, and article of manufacture for deriving and using non-linearly adapted lapped transforms (NALTs) In one embodiment, the method comprises receiving parameters of a statistical fit between local statistics of original and processed frame data, determining adaptation parameters for application of an inverse lapped transform to frame data, and filtering the frame data in response to filtering adaptation parameters.

### DESCRIPTION OF THE DRAWINGS

The present invention will be understood more fully from-the detailed description given below and from the accompanying drawings of various embodiments of the invention, which, however, should not be taken to limit the invention to the specific embodiments, but are for explanation and understanding only.

FIG. 1 is a block diagram of one embodiment of a video Coder (VC);

FIG. 2 is a block diagram of one embodiment of an LT-Parameter design module (LT-PDM);

FIG. 3 is a block diagram of one embodiment of a pre-filter;

FIG. 4 is a block diagram of one embodiment of an LT-Parameter reconstruction module (LT-PRM);

FIG. 5 is a block diagram of one embodiment of a post-filter;

FIG. 6 is a block diagram of one embodiment of a video decoder;

FIG. 7 illustrates cross-boundary vectors (horizontal direction shown);

FIG. 8 is a flow diagram of one embodiment of a process for determining and using NALT in video coder (VC);

FIG. 9 is a flow diagram of one embodiment of a process for determining the NALT parameter in the LT-PDM;

FIG. 10 is a flow diagram of one embodiment of a process for directional filtering in the pre-filter module and post-filter module;

FIG. 11 is a flow diagram of one embodiment of a process for reconstructing the NALT parameter in the LT-PRM;

FIG. 12 is a flow diagram of one embodiment of a process for determining and using NALT in video decoder; and

FIG. 13 is a block diagram of an exemplary computer system.

### DETAILED DESCRIPTION OF THE PRESENT INVENTION

A method, apparatus, and article of manufacture for deriving and using non-linearly adapted lapped transforms (NALTs). In one embodiment, the determination of the NALT is based on the adaptation of the basis functions of the transform in the encoder to local statistics of the image, and the estimation of the inverse lapped transform parameters at the decoder, while maintaining a low associated overhead which may be transmitted from the encoder to decoder. In one embodiment, the lapped transforms are adapted to local block statistics in an image resulting in an increased rate-distortion coding performance, and are constructed such as to reduce, and possibly minimize, the amount of associated overhead information transmitted from coder to decoder. In one embodiment, the adaptation is made on both the forward and inverse lapped transforms.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Overview

Embodiments of the present invention include coding with the use of a lapped transform. In one embodiment, the lapped transform is implemented by applying horizontal and vertical filtering to the boundaries of the image data, followed by application of a blocked transform. The horizontal filtering and vertical filtering may be performed in any order. When performing the horizontal filtering, the filtering extends into the neighboring blocks to the left or the right depending on whether the boundary being filtered in on the left side of the region or the right, respectively. Similarly, when performing vertical filtering, the filtering extends into the neighboring block above and below the region depending on whether the boundary being filtered is at the top or bottom, respectively, of the region.

Also, when performing the horizontal or vertical filtering, in one embodiment, all the boundaries in the frame may be filtered at the same time. That is, all boundaries being filtered with horizontal filtering are filtered before any vertical filtering is performed. In one embodiment, the blocked transform is the DCT transform; however, any transform may be used.

The techniques are adaptive in that the basis function of the transform is adapted yet uses a fixed length. In one embodiment, the transform is adapted so that the transform applied in each region of data is dependent on local statistics. That is, some statistics of the data are examined to determine whether a certain amount of filtering (e.g., stronger filtering) should be applied. In one embodiment, the statistics examined are the standard deviation or the variance of the data. The adaptation method may be the same amount in both the horizontal and vertical directions, although this is not required.

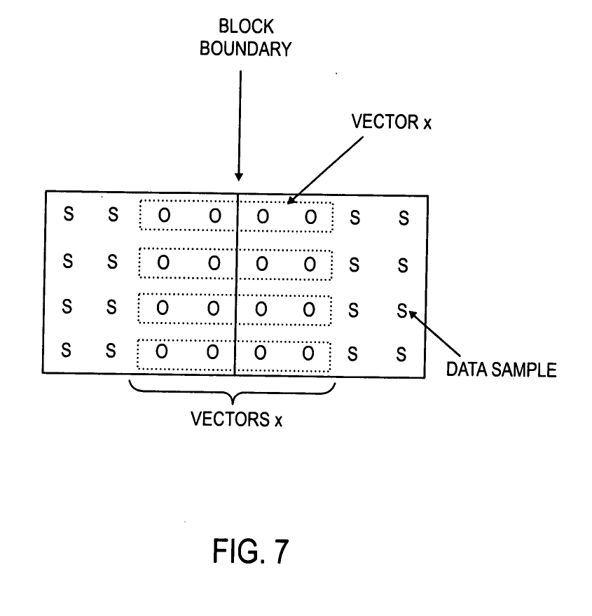

Note that the adaptation may be per vector adaptation for each vector of samples forming a boundary, such as shown in FIG. 7. Alternatively, the adaptation can be based on more than one or all of the vectors. For purposes herein, the unit of adaptation (whether one or more vectors in the block boundary) is referred to herein as the element of NALT adaptation. Note that in such a case, each vector is still filtered individually, but the filtering is based on chosen filter.

To signal the decoder as to the adaptation performed by the encoder, the encoder determines a function that represents a statistical fit between statistics (e.g., standard deviations) being used. In one embodiment, the statistical fit is between the corresponding standard deviations of the original and that of the reconstructed (inverse quantized and inverse block transformed), but still lapped, element of adaptations. In one embodiment, such functions are generated for both horizontal and vertical directions and these parameters for these functions are sent to the decoder. As discussed below, the LT-PDM identifies these functions and sends the parameters to be encoded and included in the encoded bitstream. In one embodiment, the function is a 2^{nd} order polynomial. However, other functions may be used.

An Example of an Encoder

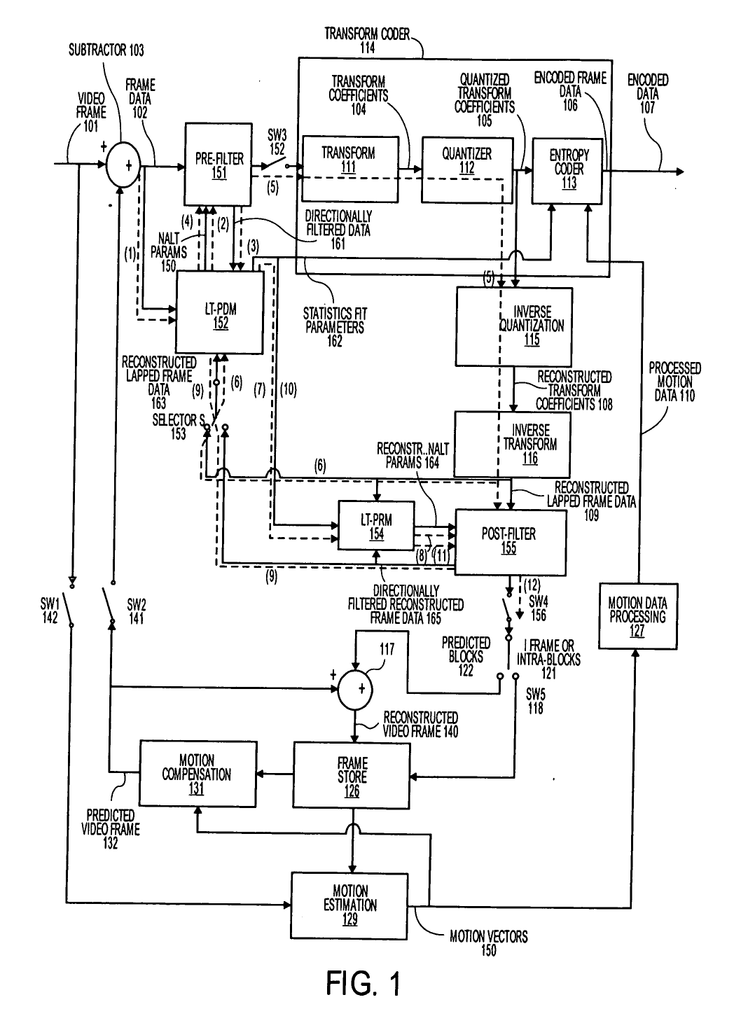

FIG. 1 is a block diagram of video coder. Referring to FIG. 1, the video coder includes a motion estimation module (MEM) 129, a motion-compensation module (MCM) 131, a transform coding module (TCM) 114, a motion data processing module (MDPM) 127, a lapped transform parameter determination module (LT-PDM) 152, a lapped transform parameter reconstruction module (LT-PRM) 154, a pre-filtering module (pre-filter) 151, a post-filtering module (post filter) 155, a frame store (memory) 126, a subtractor 103, adder 117, switches SW 118, 141, 142, 152, 156, and selector 153. The transform coding module (TCM) 114 in turn includes a transform module 111, a quantizer module 112, and an entropy coding module 113. In one embodiment, pre-filter 151 comprises a forward transform (forward filter) and post filter 152 comprises an inverse transform (inverse filter).

The frame data at the input of pre-filter (pre-filter) 151 may consist of video frames, or displaced frame difference (DFD) frames. A DFD frame is obtained in the video coder by taking the difference between data in a video frame and its prediction generated at the output of MCM 131 as customary in video coding processes. MCM 131 generates a prediction, predicted video frame 132, based on reconstructed video frames stored in frame store 126 and using motion information (i.e., motion vectors 150) generated by MEM 129.

Alternatively, when the video coder directly encodes a video frame without the use of prediction, corresponding to the intra-coding mode of conventional coders, MEM 129, MCM 131, and MDPM 127 are not utilized.

The video coder typically operates sequentially on block-partitioned frame data, which consists of luminance and chrominance values at each position in a block.

More specifically, with reference to FIG. 1, video frame 101 is input into the video coder. In cases where a prediction is generated, frame data 101 is provided to MEM 129 via switch 142, which is closed if performing prediction. Similarly, video frame 101 is coupled to one input of subtractor 103. The other input of subtractor 103 comprises predicted video frame 132 from MCM 131 via switch 141, which is closed when doing a prediction. The output of subtractor 103 is frame data 102, which is coupled to one input of pre-filter 151 and an input of LT-PDM 152, which is shown as (1) in FIG. 1. Thus, (1) can consist of a video frame if the intra-coding mode is selected, or a prediction error frame if a predicted frame is created. The two types of data are referred to herein as frame data.

In response to frame data 102, LT-PDM 152 selects the filters to be applied in one direction (e.g., horizontal) to be applied to frame data 102 by pre-filter 151. LT-PDM 152 operates on frame data to determine the filter parameters for the application of the lapped transform to the data. In one embodiment, LT-PDM 152 includes a local statistics computation module to determine statistics of block boundaries in a frame and a pre-filter parameter computation module to determine the parameters of the forward lapped transform based on local statistics.

LT-PDM 152 sends the filter parameters, NALT parameters 150, specifying the filter(s) to pre-filter 151 (shown as (2)). In response thereto, pre-filter 151 filters frame data 102 in one direction (e.g., horizontally) based on filtering parameters received from LT-PDM 152. In one embodiment, pre-filter 151 comprises a horizontal, adapted filter to filter frame data based on received parameters. The horizontally filtered data is sent from pre-filter 151 to LT-PDM 152 as directionally filtered data 161 (shown as (3)).

In response to directionally filtered data 161, LT-PDM 152 repeats the same process as was performed on frame data 102, except in the other direction (e.g., vertically) to produce another set of filter parameters corresponding to the filters that it determined should be applied to the directionally filtered data 161 (e.g., horizontally filtered data) in pre-filter 151. LT-PDM 152 sends the filter parameters as NALT parameters 150 to pre-filter 151 (shown as (4)), which uses the parameters and performs the filtering on the horizontally filtered data in the other direction (e.g., vertically). In one embodiment, pre-filter 151 comprises a vertical, adapted filter to filter frame data based on the filter parameters received from LT-PDM 152. At this point, frame data 102 has been filtered in both directions, namely horizontally and vertically.

The filtered frame data output from pre-filter 151 is sent to transform coder 114 if switch 152 is closed. As discussed above, transform coder 114 includes transforming module 111 that generates transform coefficients 104 in response to frame data 102, quantizer 112 that receives the transform coefficients 104 and generates quantized transform coefficients 105, and entropy coder 113 that receives the quantized transform coefficients and generates encoded frame data 106, which is output from transform coder 114 to create encoded data 107.

Quantized transform coefficient 105 that are output from quantizer 112 are also input to inverse quantizer 115, which, in response thereto, generates reconstructed transform coefficients 108. Inverse transform 116 receives reconstructed transform coefficients 108 and generates reconstructed lapped frame data 109. Note that the path from pre-filter 151 to the output of inverse transform 116 is shown as (5).

Reconstructed lapped frame data 109 is sent to LT-PDM 152, via selector 153, and to LT-PRM 154 (shown as (6)). LT-PDM 152 includes a statistical dependency computation module to determine parameters for fitting a functional to a dependency between the local statistics of the original frame data 102 and the corresponding local statistics in the reconstructed lapped frame data 109. In this path, the local statistics computation module of LT-PDM 152 computes the local statistics of the reconstructed, but still lapped, data at the level of the element of adaptation. In one embodiment, the statistical dependency computation module performs a least square fit between the two sets of data. The output of the statistical dependency computation module are statistics fit parameters 162 that are sent to LT-PRM 154 (shown as (7)).

In response to statistics fit parameters 162 and reconstructed frame data 109, LT-PRM 154 determines filter parameters for one direction (e.g., vertical) to be used by the inverse lapped transform of the data. In one embodiment, LT-PRM 154 comprises a local statistics computation module to determine statistics of block boundaries in a reconstructed frame, and a post-filter parameter computation module to determine filter parameters of an inverse lapped transform based on received local statistics and statistics dependency fit parameters. LT-PRM 154 sends the reconstruction NALT parameters 164 to post filter 155 (shown as (8)).

In response to reconstruction NALT parameters 164, post filter 155 filters reconstructed lapped frame data in one direction (e.g., vertically) to generate directionally filtered reconstructed frame data 165 and sends it to LT-PRM 154 and to LT-PDM 152 (as reconstructed frame data 163 based on setting of selector 153) (shown as (9)). In one embodiment, post-filter 155 comprises a vertical, adapted filter to filter reconstructed frame data based on adaptation parameters.

In response to the directionally filtered reconstructed frame data 165, LT-PDM 152 generates statistics fit parameters 162 and sends them to LT-PRM 154 (shown as (10)). In response thereto, LT-PRM 154 determines filter parameters for the other direction (e.g., horizontal) to be used by the inverse lapped transform applied by post-filter 155. LT-PRM 154 sends the filter parameters as reconstruction NALT parameters 164 to post filter 155 (shown as (11)). In response thereto, post filter 155 applies an inverse transform in a direction (e.g., horizontally) to directionally filtered reconstructed frame data 165. In one embodiment, post-filter 155 includes a horizontal, adapted filter to filter reconstructed frame data based on filter parameters.

Entropy coder 113 also receives and encodes statistics fit parameters 162 from LT-PDM 152 as well as processed motion data 110 from MDPM 126. In the case of statistics fit parameters 162, these comprise the parameters for both the horizontal and vertical directions of processing and they may be encoded together or separately as two groups.

An output of post filter 155 is also coupled via switches 156 and 118 to frame store 126 or adder 117. If processing predicted blocks, switch 118 sends the reconstructed frame data from post filter 155 to adder 117. If processing I frames or intra-blocks, switch 118 sends the reconstructed frame data from post filter 155 directly to frame store 126.

Adder adds the predicted blocks 122 to the predicted video frame 132 from MCM 131 to produce reconstructed video frame 140, which is stored in frame store 126.

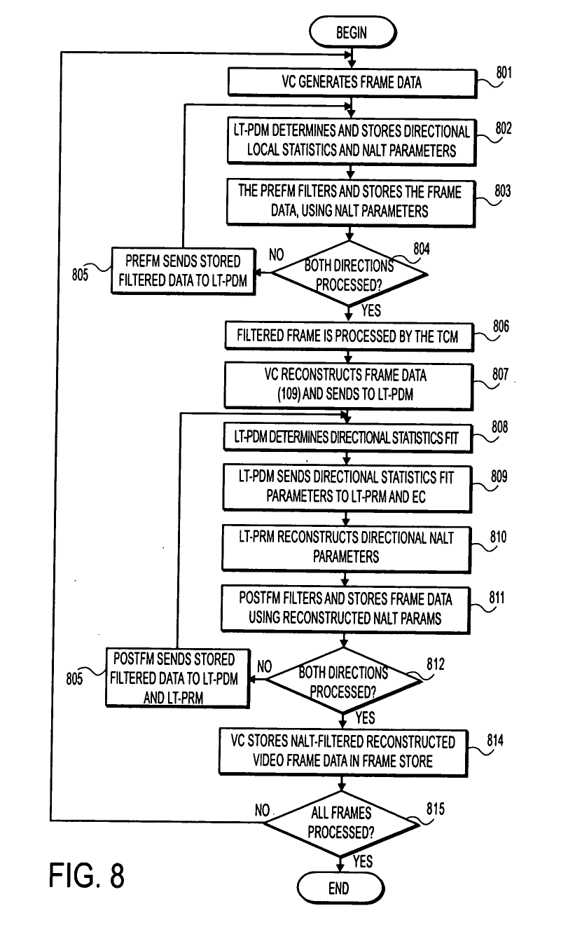

FIG. 8 is a flow diagram of one embodiment of a process for determining and using the NALT in a video coder. The process is performed by processing logic that may comprise hardware (e.g., circuitry, dedicated logic, etc.), software (such as is run on a general purpose computer system or a dedicated machine), or a combination of both.

Referring to FIG. 8, blocks from a frame are read and processed sequentially until all blocks of the current frame have been processed. Switch SW3 in FIG. 1 is open. Switches SW1, SW2, SW4 are opened or closed depending on the type of frame/blocks (intra or predicted) being processed as customary in a video coder.

The process begins by processing logic generating frame data (processing block 801). In one embodiment, the processing logic that generates the frame data in the video coder by reading video frame data present at its input. In one embodiment, the frame data may consist of input video frame data or a DFD frame as described above.

Next, processing logic determines and stores directional local statistics and NALT parameters (processing block 802). In one embodiment, the processing logic in the LT-PDM stores the directional local statistics and the NALT parameters for the current frame data for a first direction of processing (either horizontal or vertical).

Processing logic then filters directionally and stores the frame data using the NALT parameters (processing block 803). In one embodiment, processing logic in the pre-filter filters performs this filtering. Next, processing logic tests whether both directions have been processed (processing block 804). If not, processing logic sends the stored filter data to the LT-PDM (processing block 805) and the processing transitions to processing block 802 where processing continues and is repeated for the second direction of processing (either vertical or horizontal) on the directionally-filtered frame data. In one embodiment, the processing logic in the pre-filter sends the stored filter data to the LT-PDM.

After both directions have been processed, switch SW3 closes and processing logic processes the filtered frame data (processing block 806). In one embodiment, this process is performed by the transform coder module, which processes sequentially the blocks of the frame according to a conventional transform coding process. Processing logic then reconstructs the frame data and sends it to the LT-PDM (processing block 807). In one embodiment, the processing logic is in the video coder. In one embodiment, processing logic then performs an inverse quantization operation and an inverse transform are performed on the blocks of the filtered and transform coded frame, thereby obtaining a reconstructed frame (reconstructed frame data 109).

After frame data has been reconstructed, processing logic determines a directional statistics fit between the corresponding statistics of the original frame data and reconstructed frame data (reconstructed frame data 109) (processing block 808). In one embodiment, the processing logic that determines the directional statistics fit is in the LT-PDM. Processing logic sends the directional statistics fit parameters to the EC (processing block 809), and processing logic in the LT-PRM, using the reconstructed frame data and the parameters of the statistics fit, reconstructs the directional NALT parameters for the current processing direction (processing block 810) and processing logic filters the frame data for the current processing direction using the reconstructed NALT parameters and stores the filtered data (processing block 811). In one embodiment, the directional NALT parameters are reconstructed by processing logic in the LT-PRM and the frame data is filtered and stored using reconstructed NALT parameters by the post filter.

Afterwards, processing logic tests whether both directions have been processed (processing block 812). If not, processing logic sends the stored filter data to the LT-PDM and the LT-PRM (processing block 813) and processing transitions to processing block 808 where the process is repeated for the second direction of processing. In one embodiment, the stored filtered data is sent to LT-PDM and LT-PRM by processing logic in the post filter. If both directions have been processed, processing logic stores the NALT-filtered reconstruction frame data in the frame store (processing block 814) and tests whether all frames have been processed (processing block 815). If not, processing transitions to processing block 801 and the process is repeated for all frames in the video sequence being encoded. If so, the process ends.

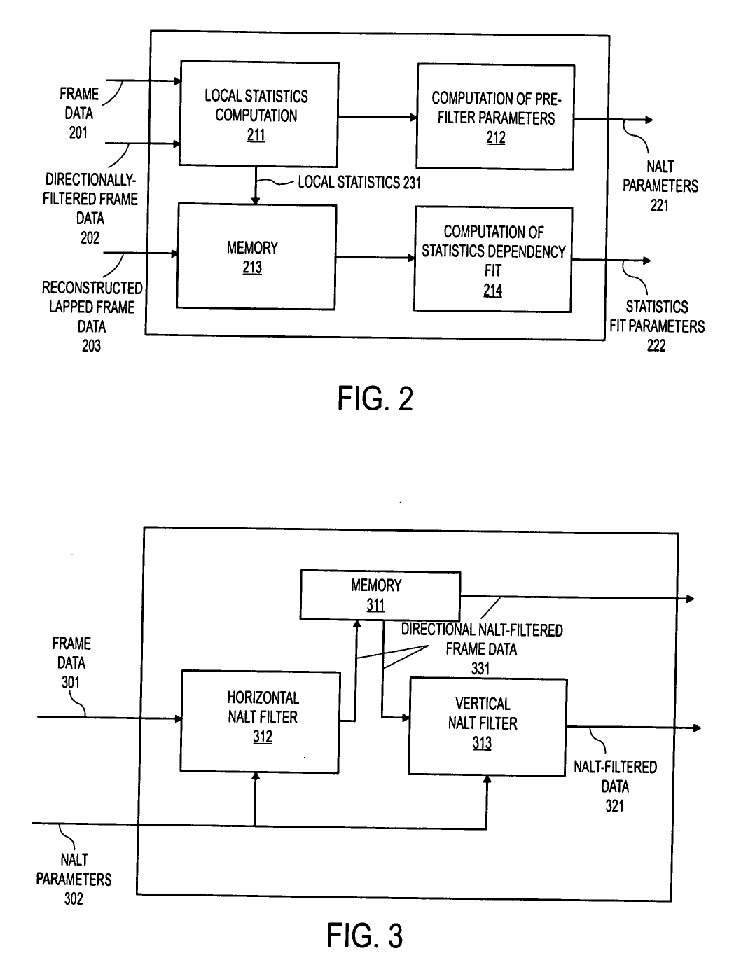

FIG. 2 is a block diagram of one embodiment of the LT-PDM. Referring to FIG. 2, the LT-PDM includes a local statistics computation module (LSCM) 211, a memory module 213, a pre-filter parameters computation module (PPCM) 212, and a statistics dependency computation module (SDCM) 214. The LT-PDM has inputs that include either the frame data 201, directionally-filtered frame data 202, or by reconstructed lapped frame data 203. The LT-PDM has outputs consisting of the directional NALT-parameters 221 and the statistics-fit parameters 222.

LSCM 211 receives frame data 201 or directionally-filtered frame data 202 and computes local statistics based on either of these inputs. The computed local statistics are stored in memory 213 and sent to PPCM 212. In response thereto, PPCM 212 computes pre-filter parameters and outputs NALT parameters 221. Memory 213 also stores reconstructed frame data 203. SDCM 214 receives local statistics 231 from memory 213 and computes a statistics dependency fit. SDCM 214 outputs statistics fit parameter 222.

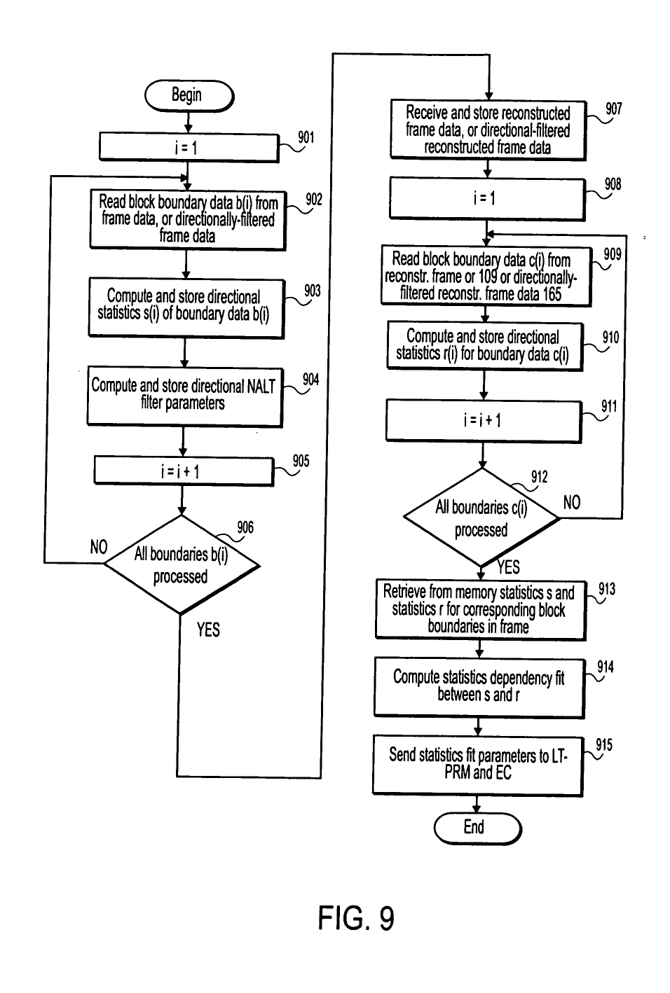

The determination of the lapped transform (NALT) parameters in one embodiment of the LT-PDM is illustrated by the flow diagram of FIG. 9. The process is performed by processing logic that may comprise hardware (e.g., circuitry, dedicated logic, etc.), software (such as is run on a general purpose computer system or a dedicated machine), or a combination of both.

Prior to describing this process, the definition of block boundary data is illustrated in FIG. 7, for the case of a boundary in the horizontal processing direction. The boundary data may consist of each or all the vectors x in a boundary illustrated in FIG. 7 (for which local statistics are computed in LSCM 211). A similar boundary is defined for the vertical processing direction.

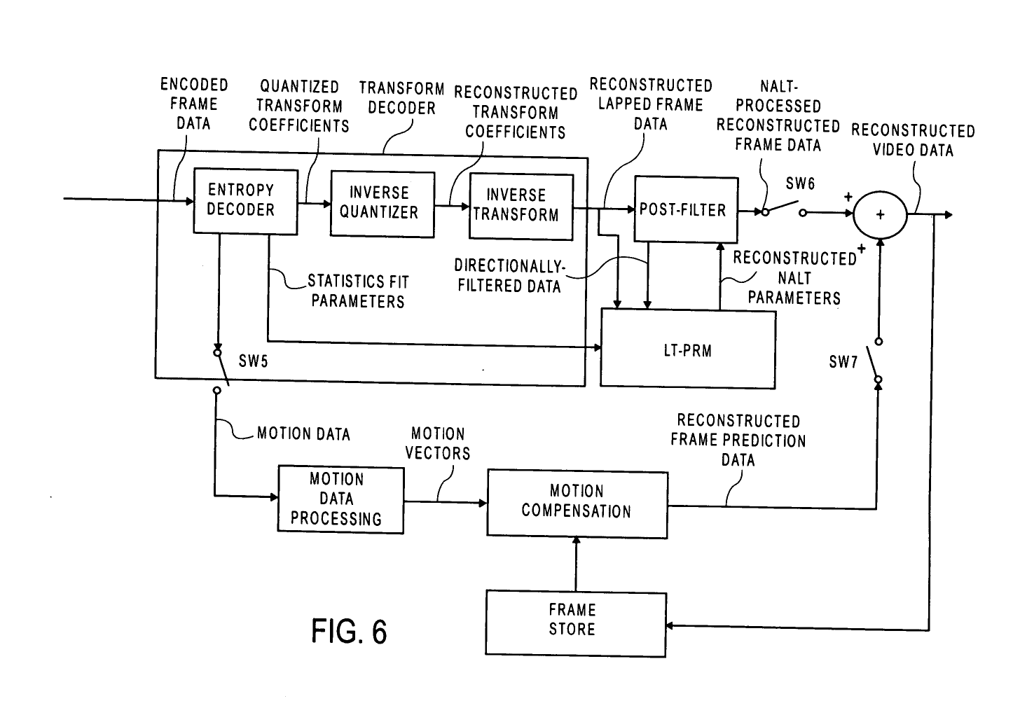

Referring to FIG. 9, operating sequentially for all the blocks in a frame, processing logic initializes an index i to 1 (processing block 901), initially retrieves block boundary data b(i) from the frame data (processing block 902), computes and stores statistics s(i) of boundary data b(i) for the current processing direction (processing block 903), and, using these statistics, computes and stores the NALT parameters corresponding to the current boundary data and current processing direction (processing block 904). The computation of the statistics s(i) for boundary data b(i) proceeds as follows in LCSM. As shown in FIG. 6, for one direction of processing (horizontal), if the two-dimensional frame data block is of size M×M, then there are M cross-block boundary vectors x, taken in one direction across the boundary between blocks (the samples of these vectors form the symbolically-denoted b(i) boundary data). In one embodiment, in order to compute the local statistics of the boundary's data samples, one computes the standard deviation of each of the cross-boundary vectors x, and averages the M standard deviations obtained. In another embodiment, in order to compute the local statistics of the boundary's data samples, one computes the standard deviation of each of the cross-boundary vectors x. In either case, the result is the local statistics s(i). That is, local statistics s(i) can be M individual statistics for each vector or could be a single number representing the average of M statistics of the M vectors in the boundary b(i).

The determination of the NALT parameters corresponding to the cross-boundary data b(i) is performed as follows in the PPCM. To define the NALT parameters, let x denote an M×1 dimensional cross-boundary vector as in FIG. 6. A NALT pre-filtering matrix containing the NALT parameters is denoted by Pₚᵣₑ and will be used in the pre-filter for pre-filtering such a vector x as follows:
y=Pₚᵣₑx, (1)
where y is the filtered cross-boundary vector. In one embodiment, for cross-boundary vectors x of size M×1, the M×M NALT pre-filtering matrix Pₚᵣₑ is computed as:

$${P}_{pre} = \frac{1}{2} [ \begin{matrix}I & J \\ J & - I\end{matrix} ] [ \begin{matrix}I & 0 \\ 0 & {V}_{1}\end{matrix} ] [ \begin{matrix}I & J \\ J & - I\end{matrix} ] , \qquad ( 2 )$$

where I is the identity matrix of size M/2×M/2, J is the reflected identity matrix of size M/2×M/2, and 0 is the matrix having all zero entries of size M/2×M/2. As an example for M=4, the matrices I and J are as follows:

$$I = [ \begin{matrix}1 & 0 \\ 0 & 1\end{matrix} ] , J = [ \begin{matrix}0 & 1 \\ 1 & 0\end{matrix} ] . \qquad ( 3 )$$

V₁ is a M/2×M/2 NALT parameter matrix, which is computed as:
V₁=I+V/α((i, u,t) (4)
where (u,t) are the indices of the entries in matrix V (e.g., for matrix V of size 2×2, u={0,1}, t={0,1}).
and

$$α ( i , u , t ) = \frac{{[ 1 + s ( i ) ]}^{m ( u , t )}}{{q}^{n ( u , i )}} ,$$

where the M/2×M/2 matrix V contains the fixed parameters of any baseline transform (e.g., a lapped biorthogonal transform, or a transform optimized globally for the entire frame), s(i) represents the statistics computed for the data samples of the element of adaptation, as described above. The operation “./” signifies element by element division of the entries in matrix V by α(i, u,t). The letter q represents the quantization step which is used by the video coding process, and m(u,t), n(u,t) represent parameters of the model, whose values are set by the user empirically. The dependency of m and n on {u,t} signifies the fact that α(i,u,t) may take different values for each entity in matrix V.

Note that in one embodiment, when dividing by α, each α could be distinct for the case of the element of adaptation being a vector in a boundary. In such a case, an index j may be added to m and n in the matrix multiplications above.

Referring back to FIG. 9, processing logic increments the index i used to specify the current block boundary being processed (processing block 905) and tests whether all block boundaries have been processed (processing block 906). If there are still block boundaries to be processed, the process transitions to processing block 902 and the process is repeated. If not, processing begins the second phase of operation of the LT-PDM.

In a second phase of the operation of LT-PDM, after the filtered frame data is processed by the transform coder and reconstructed as described before in the flow diagram of FIG. 8, the reconstructed frame data is available at the input of the LT-PDM. Then, as shown in the flow diagram of FIG. 9, processing logic in the LT-PDM stores the reconstructed frame data for the current processing direction (processing block 907). Processing logic resets the index i equal to 1 (processing block 908), and then reads block boundary data c(i) from the stored frame data from the reconstructed lapped frame data 109 or the directionally reconstructed frame data 165 (processing block 909), and computes and stores statistics r(i) of the boundary data c(i) for the current processing direction (processing block 910). As shown in FIG. 6, for one direction of processing (horizontal), if the two-dimensional frame data block is of size M×M, then there are M cross-block boundary vectors x, taken in one direction across the boundary between blocks (the samples of these vectors from the symbolically-denoted c(i) boundary data). In one embodiment, in order to compute the local statistics of the boundary's data samples, one computes the standard deviation of each of the cross-boundary vectors x, and averages the M standard deviations obtained. The result is the local statistics r(i). In another embodiment where the element of adaptation is one vector of samples in the block boundary, in order to compute the local statistics of the boundary's data samples, one computes the standard deviation of each of the cross-boundary vectors x. The result is the local statistics r(i) corresponding to this case.

Processing logic then increments the index i by 1 (processing block 911) and tests whether there are still block boundaries to be processed for the current processing direction (processing block 912). If so, the process transitions to processing block 909 and the process described above is repeated. When all boundaries have been processed, the process transitions to processing block 913 where processing logic in the LT-PDM retrieves from memory the computed statistics s and statistics r of the boundary data of original and reconstructed data for the corresponding element of adaptation in the frame, and computes a dependency fit between the two sets of statistics (processing block 914). In one embodiment, this dependency fit is computed in the following way. For one processing direction, s and r are each an N×1 vector of boundary statistics s(i), and r(i) respectively, computed as previously described. A best-fitting polynomial curve g is fit to this dependency based on a least-squares criterion. After fitting this functional g, an approximation of s(i) denoted by \tilde{s}(i) results as:
\tilde{s}(i)=g(r(i)), (5)
where i indexes the block boundaries in a frame in one direction of processing. It is possible to have a different functional g determined for each processing direction (horizontal and vertical). The functional g may be the functional of the form:
g(z)=αₙ₋₁zⁿ⁻¹+αₙ₋₂zⁿ⁻²+ . . . +α₀, (6)
where z is a dummy variable, and n is the polynomial order. In one embodiment, n equals 3 such that there are three parameters of g per direction of processing. These are referred to herein as the parameters of the statistics dependency fit.

Finally, processing logic sends the fit parameters to both the LT-PRM and to the entropy coder EC for coding (processing block 915) and the process ends.

FIG. 3 is a block diagram of one embodiment of the pre-filter module (pre-filter). Referring to FIG. 3, the pre-filter has inputs that include frame data 301, and the NALT parameters 302, determined by the LT-PDM. The pre-filter has an output consisting of directionally-filtered frame data, or fully-filtered frame data (both directions filtered) 321.

Horizontal NALT filter 312 receives frame data 312 and NALT parameters 302 and generates directional NALT-filtered frame data 331, which is stored in memory 301. Vertical NALT filter 313 receives directional NALT-filtered frame data 331 and NALT parameters 302 and generates NALT-filtered data 321.

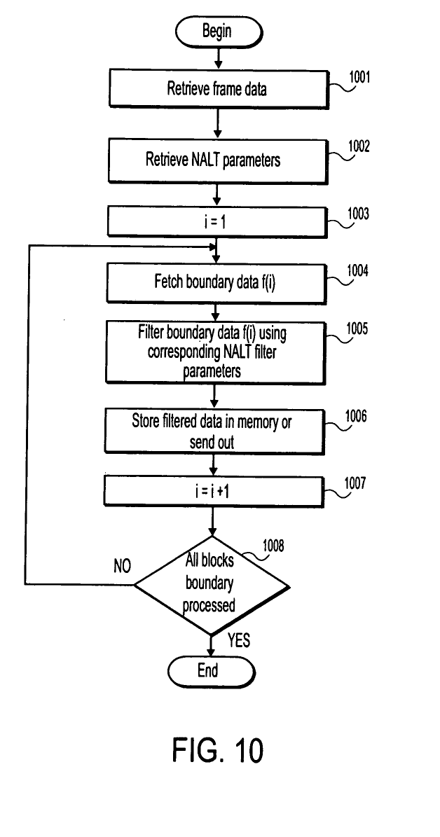

The operation of one embodiment of the pre-filter is more specifically illustrated by the flow diagram of FIG. 10. The pre-filter operates sequentially in two processing directions (horizontal and vertical). The order of directional processing can be changed (vertical, then horizontal). Since the pre-filter operates similarly for the two processing directions, only a one-directional process description is necessary.

The process of FIG. 10 is performed by processing logic that may comprise hardware (e.g., circuitry, dedicated logic, etc.), software (such as is run on a general purpose computer system or a dedicated machine), or a combination of both. (In one embodiment, the process is performed by the pre-filter and the post filter.)

Referring to FIG. 10, the process begins by processing logic retrieving frame data or directionally-filtered frame data (if the second direction of processing is being executed) (processing block 1001) and processing logic retrieving the corresponding NALT parameters from LT_PDM (processing block 1002). Processing logic also sets an index variable equal to 1 for indexing the block boundary data (processing block 1003).

Thereafter, processing logic fetches boundary data f(i) (processing block 1004), directionally filters each boundary data f(i) in the frame data using corresponding NALT filter parameters, as in Eq. (1) (processing block 1005). Thus, each cross-boundary vector x in the boundary data f(i) (as in FIG. 6) is filtered using Eq. (1). After filtering in the first direction, processing logic stores the filtered data in memory and outputs the filtered data at the output of pre-filter (processing block 1006). Then processing logic increments the index variable i by one (processing block 1007) and tests whether all block boundaries have been processed (processing block 1008). If not, processing transitions to processing block 1004 and the process continues from there. If the boundaries for all blocks in the frame in each processing direction have been processed, the process ends.

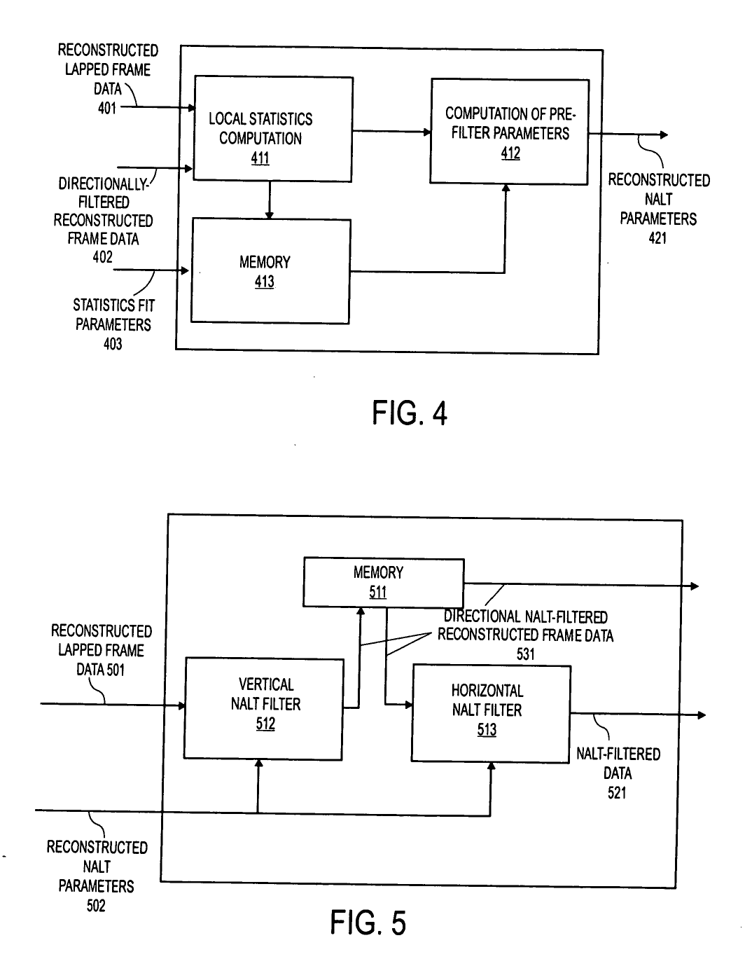

FIG. 4 is a block diagram of one embodiment of a LT-PRM. The LT-PRM has as inputs either the reconstructed lapped frame data 401 or the directionally-filtered reconstructed frame data 402, and the statistics fit parameters 403 (of polynomial g in Eq. (6)). The LT-PRM has as an output the reconstructed directional NALT matrix parameters 421.

Local statistics computation module (LSCM) 411 receives frame data 401 and directionally-filtered reconstructed frame data 402 and computes local statistics. The computed local statistics are stored in memory 413 and sent to post-filter parameters computation module (PPCM 412). In response thereto, PPCM 412 computes post-filter parameters and outputs reconstructed NALT parameters 421. Memory 413 also stores reconstructed frame data 403.

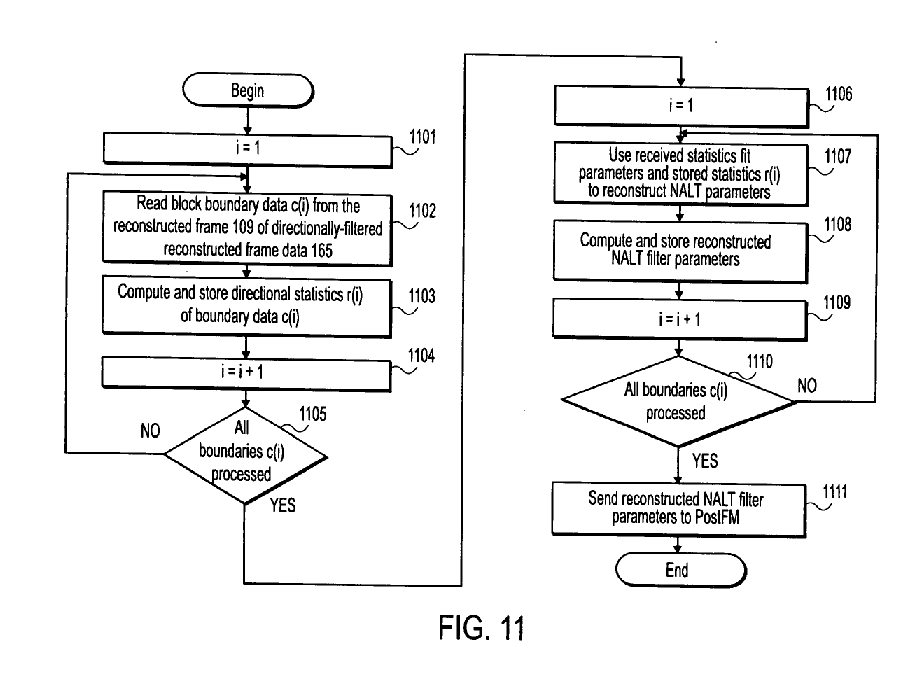

The operation of one embodiment of the LT-PRM is illustrated by the flow diagram of FIG. 11. The process is performed by processing logic that may comprise hardware (e.g., circuitry, dedicated logic, etc.) software (such as is run on a general purpose computer system or a dedicated machine), or a combination of both.

Referring to FIG. 11, the process begins by processing logic initializing an index variable i equal to one (processing block 1101). Then operating sequentially for all the block boundaries in a frame, processing logic in the LT-PRM initially retrieves block boundary data c(i) from the reconstructed frame data 109 or directionally-filtered reconstructed frame data 165 (if the second direction of processing is being executed) (processing block 1102), and computes and stores statistics r(i) of boundary data c(i) for the current processing direction (processing block 1103). As shown in FIG. 6 for one direction of processing (horizontal), if the two-dimensional frame data block is of size M×M, then there are M cross-block boundary vectors x, taken in one direction across the boundary between blocks (the samples of these vectors form the symbolically-denoted c(i) boundary data). In one embodiment, in order to compute the local statistics of the boundary's data samples, one computes the standard deviation of each of the cross-boundary vectors x, and averages the M standard deviations obtained. The result is the local statistics r(i). In another embodiment where the element of adaptation is one vector of samples in the block boundary, in order to compute the local statistics of the boundary's data samples, one computes the standard deviation of each of the cross-boundary vectors x. The result is the local statistics r(i) corresponding to this case.

Then processing logic increments the index variable i by one (processing block 1104) and tests whether all boundaries c(i) have been processed. If there are still block boundaries unprocessed, the process transitions to processing block 1102 and the process described above is repeated.

In the second phase of its operation, processing logic transitions to processing block 1106 where the index variable i is reset equal to one and processing logic in the LT-PRM receives the statistics fit parameters from LT-PDM (processing block 1107). The LT-PRM now operates sequentially on the block boundary data corresponding to the current direction being processed. Using the statistics fit parameters (as in Eq. (6)) received from the LT-PDM and the stored directional statistics r, processing logic in the LT-PRM reconstructs and stores the directional NALT parameters for the boundary data processed (processing block 1108). In one embodiment, the reconstruction of the NALT parameters is done as follows.

The LT-PRM receives from LT-PDM the parameters of the polynomial g in Eq. (6), and computes statistics r(i) corresponding to each boundary in the reconstructed frame for the current processing direction. Using these, the estimate of the original boundary-based statistics \tilde{s}(i) are computed as:
\tilde{s}(i)=g(r(i)), (7)
where i indexes the boundary statistics in a given processing direction.
Using \tilde{s}(i), the reconstructed NALT parameters are computed to form the post-filtering matrix Pₚₒₛₜ:

$${P}_{post} = \frac{1}{2} [ \begin{matrix}1 & J \\ J & - I\end{matrix} ] [ \begin{matrix}I & 0 \\ 0 & {V}_{2}\end{matrix} ] [ \begin{matrix}I & J \\ J & - I\end{matrix} ] , \qquad ( 8 )$$

where I, J have the same meaning as described in Eq. (3), and
V₂=[I+V.|\tilde{α}(i)]⁻¹,
and

$$\tilde{α} ( i , u , t ) = \frac{{[ 1 + \tilde{s} ( i ) ]}^{m ( u , t )}}{{q}^{n ( u , t )}} ,$$

where as before in Eq. (4), V is a known, fixed matrix of parameters, \tilde{s}(i) is computed as in Eq. (7), q is the quantization step, and m, n are empirical parameters chosen by the user, and may depend on (u,t), the indices of the entries in matrix V.

Processing logic then increments the index variable i by one (processing block I 109) and tests whether all boundaries c(i) have been processed (processing block 1110). If there are block boundaries unprocessed, the process transitions to processing block 1107 and the process described above is repeated. When all block boundaries for the current processing direction have been processed as described above, processing logic in the LT-PRM sends the corresponding computed NALT parameters to the post filter (processing block 1111) and the process ends.

FIG. 5 is a block diagram of one embodiment of the post-filter module (post filter). The post filter has inputs that include the reconstructed frame data 501 and the reconstructed NALT parameters 502. The post filter has outputs that consist of directionally-filtered frame data, or fully-filtered frame data (both directions filtered 501). Similarly to the pre-filter described above, the post filter operates sequentially in two processing directions (horizontal and vertical). The order of directional processing can be changed (vertical, then horizontal), according to the order of execution by the pre-filter. The post-filter module operates similarly to the pre-filter, with the distinction that its input data is as specified above. Horizontal NALT filters 512 receive reconstructed frame data 512 and NALT parameters 502 and generates directional NALT-filtered reconstructed frame data 531 that is stored in memory 501. Vertical NALT filter 513 receives directional NALT-filtered reconstructed frame data 531 and NALT parameters 502 and generates NALT-filtered data 521. In one embodiment, the post-filtering operation is then specified as:
y=Pₚₒₛₜx, (9)
where x now represents a cross-boundary vector in the reconstructed frame, for a direction of processing, and y represents the post-filtered cross-boundary vectors using the NALT post filtering matrix Pₚₒₛₜ.

FIG. 6 is a block diagram of one embodiment of a video decoder (VD) that uses NALT. In one embodiment, the video decoder comprises a lapped transform parameter reconstruction module (LT-PRM) to determine adaptation parameters for application of an inverse lapped transform to frame data, and a post-filter module to perform filtering on the data in response to filtering adaptation parameters.

More specifically, referring to FIG. 6, the video decoder includes a transform decoder (TD), an LT parameter reconstruction module (LT-PRM), a post-filter (post filter), a frame store (memory), a motion data processing module, and a motion compensation module. The inverse transform followed by post-filtering implements the inverse NALT. The transform decoder block includes an entropy decoder, an inverse quantizer, and an inverse transform module.

In one embodiment, the video decoder processes frame data by retrieving frame data from the transform decoder; for one processing direction, determining directional local statistics of the frame data, determining inverse lapped transform adaptation parameters, and post-filtering the frame data based on the adaptation parameters; and repeating the process for another processing direction. In one embodiment, the inverse lapped transform adaptation parameters are determined by retrieving frame data, computing and storing local directional statistics of frame data; and determining the inverse lapped transform adaptation parameters using received statistics dependency fit parameters and local directional statistics of frame data.

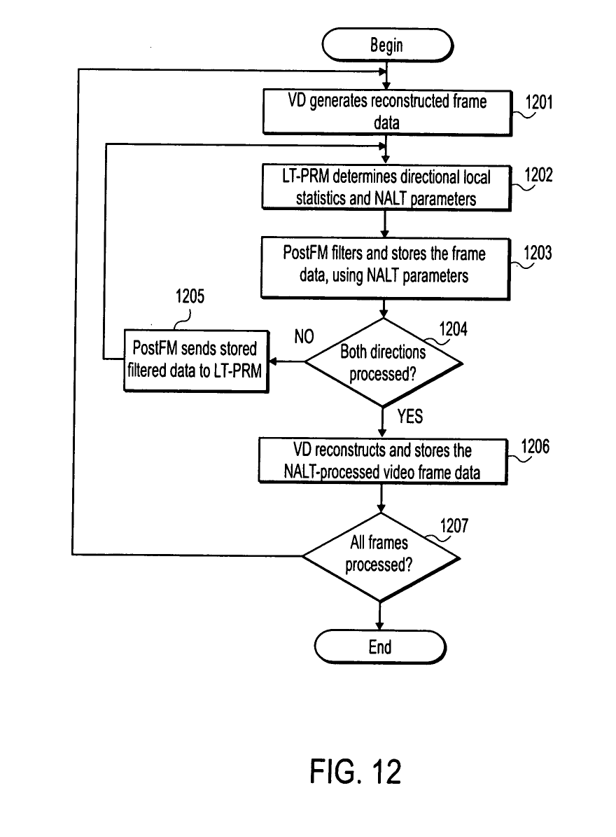

FIG. 12 is a flow diagram of one embodiment of a video decoding process performed by the video decoder. The process is performed by processing logic that may comprise hardware (e.g., circuitry, dedicated logic, etc.), software (such as is run on a general purpose computer system or a dedicated machine), or a combination of both.

Referring to FIG. 12, the process begins by processing logic generating reconstructed frame data (processing block 1201). In one embodiment, the reconstructed frame data are generated by the video decoder. The video decoder operates according to a conventional decoding process to generate reconstructed frame data at the output of the transform decoder and input of the post-filter post filter.

Based on the reconstructed frame data, for the current processing direction, processing logic determines the directional local statistics of the block boundaries c(i) in the reconstructed frame data similarly to the LT-PRM process described above in the video coder (processing block 1202). The difference is that in the decoder, the LT-PRM receives the local statistics fit parameters from the entropy decoder (the decoder does not include a LT-PDM). In one embodiment, the directional local statistics in NALT parameters are determined by processing logic in the LT-PRM. By using the statistics fit parameters (polynomial g parameters) received from the entropy decoder and the computed local statistics r(i), the LT-PRM determines the NALT matrix parameters as described in the LT-PRM process taking place in the video coder, with the distinction that now LT-PRM receives the statistics dependency fit parameters (of polynomial g in Eq. (6)) from the entropy decoder.

After determining the directional local statistics in NALT parameters, using the NALT parameters, processing logic directionally filters the reconstructed frame data as described in the post filter process in the encoder and stores the frame data (processing block 1203). In one embodiment, the frame data is stored using the NALT parameters by the post filter.

After filtering the frame data, processing logic tests whether both directions have been processed (processing block 1204). If not, processing logic sends the stored filter data to the LT-PRM (processing block 1205) and transitions to processing block 1202 where the process is repeated for the other direction. In one embodiment, the stored filtered data is sent to the LT-PRM by processing logic in the post filter.

Once both directions have been processed, processing logic determines and stores the video frame data using the NALT-filtered reconstructed frame data, according to a conventional video decoding process (processing block 1206) and then tests whether all frames have been processed (processing block 1207). If not, processing transitions to processing block 1201 and the process is repeated for all frames remaining to be decoded in the video sequence. If all frames have been processed, the process ends.

An Example of a Computer System

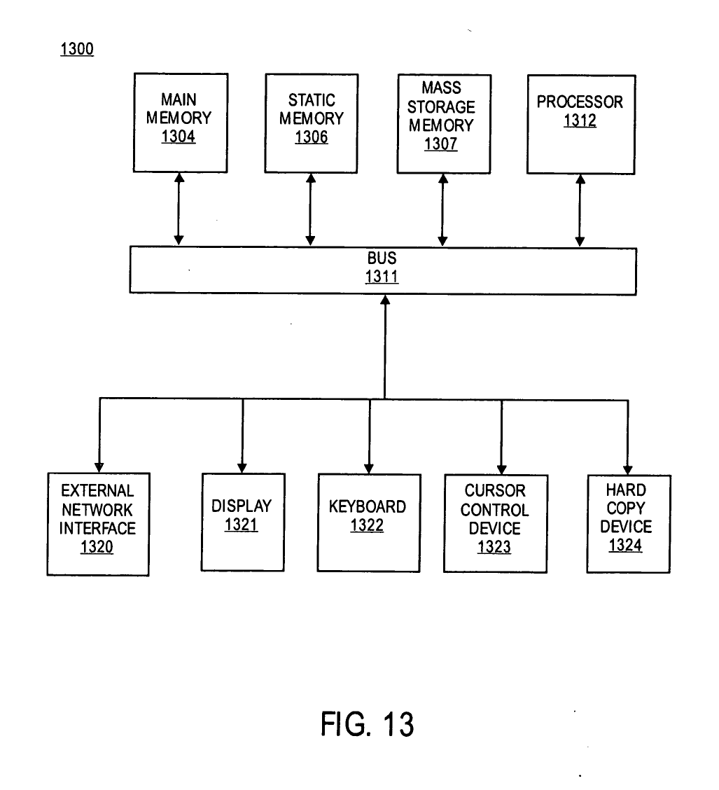

FIG. 13 is a block diagram of an exemplary computer system that may perform one or more of the operations described herein. Referring to FIG. 13, computer system 1300 may comprise an exemplary client or server computer system. Computer system 1300 comprises a communication mechanism or bus 1311 for communicating information, and a processor 1312 coupled with bus 1311 for processing information. Processor 1312 includes a microprocessor, but is not limited to a microprocessor, such as, for example, Pentium™, PowerPC™, etc.

System 1300 further comprises a random access memory (RAM), or other dynamic storage device 1304 (referred to as main memory) coupled to bus 1311 for storing information and instructions to be executed by processor 1312. Main memory 1304 also may be used for storing temporary variables or other intermediate information during execution of instructions by processor 1312.

Computer system 1300 also comprises a read only memory (ROM) and/or other static storage device 1306 coupled to bus 1311 for storing static information and instructions for processor 1312, and a data storage device 1307, such as a magnetic disk or optical disk and its corresponding disk drive. Data storage device 1307 is coupled to bus 1311 for storing information and instructions.

Computer system 1300 may further be coupled to a display device 1321, such as a cathode ray tube (CRT) or liquid crystal display (LCD), coupled to bus 1311 for displaying information to a computer user. An alphanumeric input device 1322, including alphanumeric and other keys, may also be coupled to bus 1311 for communicating information and command selections to processor 1312. An additional user input device is cursor control 1323, such as a mouse, trackball, trackpad, stylus, or cursor direction keys, coupled to bus 1311 for communicating direction information and command selections to processor 1312, and for controlling cursor movement on display 1321.

Another device that may be coupled to bus 1311 is hard copy device 1324, which may be used for marking information on a medium such as paper, film, or similar types of media. Another device that may be coupled to bus 13 11 is a wired/wireless communication capability 1325 to communication to a phone or handheld palm device.

Note that any or all of the components of system 1300 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

I claim:

1. A method comprising:
receiving parameters of a statistical fit between local statistics of original and processed frame data;
determining adaptation parameters for application of an inverse lapped transform to frame data; and
filtering the frame data in response to filtering adaptation parameters.

2. The method defined in claim 1 wherein determining adaptation parameters for application of an inverse lapped transform to frame data comprises:
for a first processing direction,
determining directional local statistics of the frame data, the directional local statistics corresponding to the first processing direction,
determining inverse lapped transform adaptation parameters based on the directional local statistics and the statistics fit parameters for the first processing direction.

3. The method defined in claim 2 further comprising:
for a second processing direction,
determining directional local statistics of the frame data, the directional local statistics corresponding to the second processing direction,
determining inverse lapped transform adaptation parameters based on the directional local statistics and the statistics fit parameters for the second processing direction.

4. The method defined in claim 2 wherein the local statistics correspond to standard deviations.

5. The method defined in claim 2 further comprising retrieving the frame data from a transform decoder.

6. The method defined in claim 2 further comprising:
retrieving frame data; and
computing and storing local directional statistics of frame data;
wherein determining the inverse lapped transform adaptation parameters comprises determining the inverse lapped transform adaptation parameters using received statistics dependency fit parameters and local directional statistics of frame data.

7. The method defined in claim 5 wherein the statistics dependency fit parameters correspond to a 2^{nd} order polynomial.

8. An article of manufacture having one or more computer readable media storing instructions thereon which, when executed by a system, cause the system to perform a method comprising:
receiving parameters of a statistical fit between local statistics of original and processed frame data;
determining adaptation parameters for application of an inverse lapped transform to frame data; and
filtering the frame data in response to filtering adaptation parameters.

9. A video decoder comprising:
a lapped transform parameter reconstruction module to determine adaptation parameters for application of an inverse lapped transform to frame data; and
a post-filter module to perform filtering on the data in response to filtering adaptation parameters.

10. The video decoder defined in claim 9 wherein the lapped transform parameter reconstruction module determines adaptation parameters for application of an inverse lapped transform to frame data by, for two processing directions, performed one direction at a time,
determining directional local statistics of the frame data, the directional local statistics corresponding to the first processing direction,
determining inverse lapped transform adaptation parameters based on the directional local statistics and statistics fit parameters, and wherein filtering the frame data is based on the inverse lapped transform adaptation parameters based on the directional local statistics.

11. The video decoder defined in claim 9 wherein the local statistics correspond to standard deviations.

12. The video decoder defined in claim 9 wherein the lapped transform parameter reconstruction module determines the inverse lapped transform adaptation parameters using received statistics dependency fit parameters and local directional statistics of frame data.

13. The video decoder defined in claim 12 wherein the statistics dependency fit parameters correspond to a 2^{nd} order polynomial.

14. The video decoder defined in claim 9 further comprising a transform decoder to generate the frame data.

15. The video decoder defined in claim 9 wherein the lapped transform parameter reconstruction module comprises:
a local statistics computation module to compute local statistics in response to frame data;
a memory coupled to the local statistics computation module to store computed local statistics;
a post-filter parameters computation module to compute post-filter parameters in response to the computed statistics and output reconstructed NALT parameters.

16. A video coder for encoding the data in a video frame, the video coder comprising:
a first module to operate on frame data to determine adaptation parameters for the application of a lapped transform to the data;
a pre-filter to filter the data based on the filtering adaptation parameters received from the first module;
a second module to operate on reconstructed frame data to determine the adaptation parameters to be used by inverse lapped transform of the data; and
a post-filter to filter reconstructed frame data based on received reconstructed lapped transform adaptation parameters.

17. The encoder defined in claim 16 wherein the first module comprises:
a local statistics computation module to determine statistics of block boundaries in a frame;
a pre-filter parameter computation module to determine the adaptation parameters of the forward lapped transform based on local statistics; and
a statistical dependency computation module to determine parameters of fitting a functional to a dependency between the local statistics of the frame data and the corresponding local statistics in the reconstructed frame data.

18. The encoder defined in claim 16 wherein the pre-filter comprises:
a horizontal, adapted filter to filter frame data based on received adaptation parameters; and
a vertical, adapted filter to filter frame data based on the received adaptation parameters.

19. The encoder defined in claim 16 wherein the second module comprises:
a local statistics computation module to determine statistics of block boundaries in a reconstructed frame; and
a post-filter parameter computation module to determine adaptation parameters of an inverse lapped transform based on received local statistics and statistics dependency fit parameters.

20. The encoder defined in claim 16 wherein the post-filter comprises:
a horizontal, adapted filter to filter reconstructed frame data based on adaptation parameters; and
a vertical, adapted filter to filter reconstructed frame data based on adaptation parameters.

21. A method for video encoding data in a video frame, the method comprising:
determining adaptation parameters for an application of a lapped transform to the data;
filtering the data based on the adaptation parameters;
determining the adaptation parameters to be used by inverse lapped transform of the data based reconstructed frame data; and
filtering the reconstructed frame data based on determined inverse lapped transform adaptation parameters.

22. The encoding method defined in claim 21 wherein determining adaptation parameters for an application of a lapped transform to the data comprises:
determining statistics of block boundaries in a frame;
determining the adaptation parameters of the forward lapped transform based on local statistics; and
determining parameters of fitting a functional to a dependency between the local statistics of the frame data and the corresponding local statistics in the reconstructed lapped frame data.

23. The encoding method defined in claim 21 wherein filtering the data based on the adaptation parameters comprises:
performing a horizontal filtering operation to filter frame data based on received adaptation parameters; and
performing a vertical filtering operation to filter frame data based on the received adaptation parameters.

24. The encoding method defined in claim 21 wherein determining the adaptation parameters to be used by inverse lapped transform of the data based reconstructed frame data comprises:
determining statistics of block boundaries in a reconstructed frame; and
determining adaptation parameters of an inverse lapped transform based on determined local statistics and statistics dependency fit parameters.

25. The encoding method defined in claim 21 wherein post-filtering comprises:
performing horizontal filtering operation to filter reconstructed frame data based on adaptation parameters; and
performing vertical filtering operation to filter reconstructed frame data based on adaptation parameters.
